(19) United States
(12) Patent Application Publication
(10) Pub. No.: US 2010/0141091 A1
(43) Pub. Date: Jun. 10, 2010

(54) ULTRASONIC MOTOR

(75) Inventor: Tetsuyuki Sakamoto, Hachioji-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/634,130

(22) Filed: Dec. 9, 2009

(30) Foreign Application Priority Data
Dec. 9, 2008 (JP) 2008-313569

(51) Int. Cl. H02N 2/04

(52) U.S. Cl. 310/323.16

(57) ABSTRACT

An ultrasonic motor in which longitudinal vibration and flexural vibration are induced at the same time to generate elliptical vibration and driving force is obtained from the elliptical vibration to drive a driven body relatively. The ultrasonic motor includes a piezoelectric device, friction contact members which are disposed on the piezoelectric device to transmit the driving force to the driven body, a holding member which is disposed on the piezoelectric device and positioned and held within a case, a pressure member which is formed integrally with the holding member to press the friction contact members to the driven body via the piezoelectric device so that the driven body is capable of being driven under friction, and a pressure adjusting mechanism which adjusts the pressure of the pressure member to be applied to the piezoelectric device.

### CROSS-REFERENCE TO RELATED APPLICATIONS

This application is based upon and claims the benefit of priority from prior Japanese Patent Application No. 2008-313569, filed Dec. 9, 2008, the entire contents of which are incorporated herein by reference.

### BACKGROUND OF THE INVENTION

1. Field of the Invention

The present invention relates to an ultrasonic motor for use as, for example, an image vibration correcting unit of a digital camera or an actuator of an autofocus (AF) lens or the like.

2. Description of the Related Art

Generally, in this kind of the ultrasonic motor, voltage is applied to a piezoelectric device which serves as a transducer (an oscillator) so that longitudinal vibration and flexural vibration are induced in the piezoelectric device, thereby producing elliptical vibration (oscillation) in the piezoelectric device. The ultrasonic motor transmits this elliptical vibration to a driven body via a friction contact member so as to drive the driven body by friction.

The ultrasonic motor using such a piezoelectric device has been disclosed in, for example, Japanese Patent No. 3825643. In this ultrasonic motor, with the protrusion of the transducer placed movably on a rail, a spring member serving as a pressure means is disposed on the top surface of the transducer such that it is sandwiched by a rubber seat and a fixing plate. Consequently, the protrusion of the transducer is disposed and pressed on the rail by a spring force of the spring member so that the rail can be driven with friction. As a result, when elliptical vibration is generated in the transducer, the driving force of the spring member is transmitted to the rail and then, the same rail is driven via a rotating member.

### BRIEF SUMMARY OF THE INVENTION

The present invention has been achieved in view of the above-described circumstances and an object of the invention is to provide an ultrasonic motor capable of assembling facilitate and simplify with a simple structure.

The present invention provides an ultrasonic motor in which longitudinal vibration and flexural vibration are induced at the same time to generate elliptical vibration and driving force is obtained from the elliptical vibration to drive a driven body relatively, the ultrasonic motor comprising: a piezoelectric device; friction contact members which are disposed on the piezoelectric device to transmit the driving force to the driven body; a holding member which is disposed on the piezoelectric device and positioned and held within a case; a pressure member which is formed integrally with the holding member to press the friction contact members to the driven body via the piezoelectric device so that the driven body is capable of being driven under friction; and a pressure adjusting mechanism which adjusts the pressure of the pressure member to be applied to the piezoelectric device.

With the above-described structure, in the piezoelectric device, the pressure member integrated with the holding member has a desired spring performance (pressure) and then, the holding member is installed within the case. Thus work for installing the spring member 16 on the holding member 15 with setting of the initial spring force is eliminated thereby facilitating and simplifying the assembly work of the ultrasonic motor.

As described above, the present invention enables to provide the ultrasonic motor capable of assembling facilitate and simplify with a simple structure.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory plan view showing the schematic configuration of an ultrasonic motor according to an embodiment of the present invention;

FIG. 2 is a plan view showing a state of the ultrasonic motor of FIG. 1 as viewed from its side face (in direction X);

FIG. 3 is an explanatory plan view showing an example of production of a spring member of FIG. 1;

FIG. 4 is an explanatory plan view showing the schematic configuration of an ultrasonic motor according to another embodiment of the present invention;

FIG. 5 is a plan view showing a state of the ultrasonic motor of FIG. 4 as viewed from its side face (in direction X);

FIG. 6 is an explanatory plan view showing the schematic configuration of an ultrasonic motor according to still another embodiment of the present invention;

FIG. 7 is an explanatory plan view showing the schematic configuration of an ultrasonic motor according to still another embodiment of the present invention;

FIG. 8 is a plan view showing a state of the ultrasonic motor of FIG. 7 as viewed from its side face (in direction X);

FIG. 9 is an exemplary plan view showing an example of production of the spring member of FIG. 7;

FIG. 10 is a plan view showing another example of a resilient section of the spring member of FIG. 7;

FIG. 11 is a sectional view taken along line 11-11 of FIG. 10;

FIG. 12 is an exemplary plan view showing an example of production of the spring member of FIG. 10;

FIG. 13 is an exemplary plan view showing the schematic configuration of an ultrasonic motor according to still another embodiment of the present invention;

FIG. 14 is a plan view showing a state of the ultrasonic motor of FIG. 13 as viewed from its side face;

FIG. 15 is an exemplary plan view showing the schematic configuration of an ultrasonic motor according to still another embodiment of the present invention; and

FIG. 16 is an explanatory plan view showing the schematic configuration of an ultrasonic motor according to still another embodiment of the present invention.

### DETAILED DESCRIPTION OF THE INVENTION

Hereinafter, embodiments of the present invention will be described in detail with reference to the drawings.

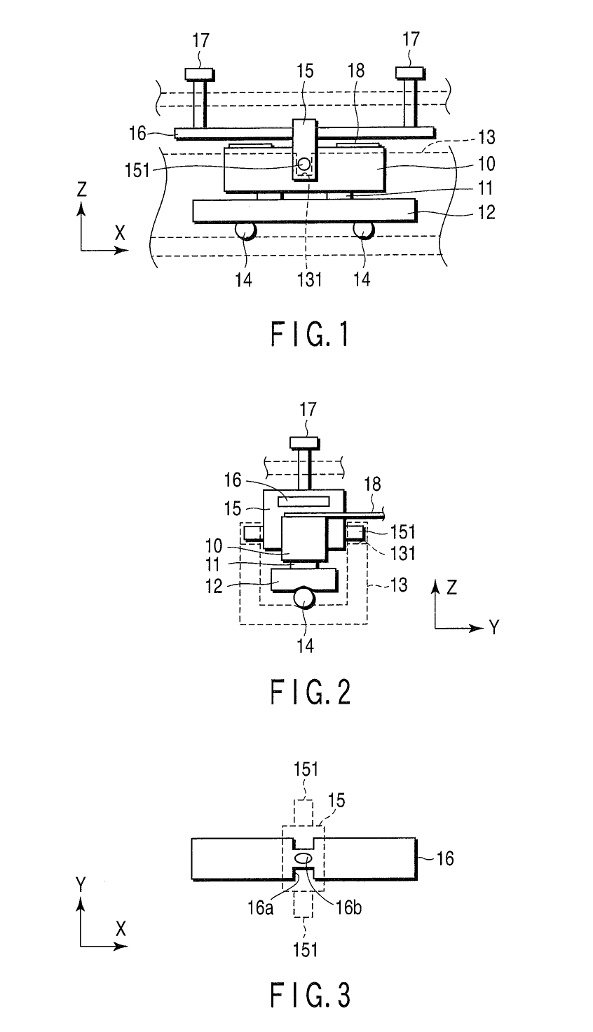

FIG. 1 is a view showing an ultrasonic motor according to an embodiment of the present invention. A piezoelectric device 10 is composed of a plurality of laminated electrode plates, for example. The piezoelectric device 10 is formed into a rectangular shape. When a voltage is applied to each electrode plate, the longitudinal vibration and flexural vibration of the piezoelectric device 10 are induced at the same time thereby producing the elliptical vibration.

Two friction contact members 11 are fixed to the bottom surface of the piezoelectric device 10 at a desired interval with adhesive agent, corresponding to, for example, the antinode (loop) of the flexural vibration. The friction contact members 11 make contact with a driven body 12 (see FIG. 2). The driven body 12 is provided such that it can be moved freely in direction X with respect to a case 13 via a plurality of rolling members 14 such as a ball.

A holding member 15 having a substantially E shape is fixed to the piezoelectric device 10 in order to surround three surfaces including the top surface of, for example, the piezoelectric device 10 with, for example, adhesive agent. The position where the holding member 15 is fixed is a position corresponding to nodes of the longitudinal vibration of the piezoelectric device 10. The holding member 15 is disposed separately from the case 13. This holding member 15 is formed of, for example, a resin material. A sheet-like spring member 16 which is a pressure member made of, for example, metal material, is formed integrally by insert molding and installed on the top surface side of the holding member 15 along the lengthwise direction (direction X) of the piezoelectric device 10. The spring member 16 is disposed on the top surface side of the holding member 15 at the intermediate portion of the spring member 16 in direction X. The spring member 16 has a desired spring performance. The spring member 16 brings (presses) the friction contact member 11 into pressure contact with the driven body 12 via the piezoelectric device 10 so that the driven body 12 can be driven with friction.

Threaded members 17 which constitute a pressure adjusting mechanism are disposed on both ends of the spring member 16 in direction X. The threaded members 17 are provided in the case 13 such that their screw-engagement can be adjusted freely. The threaded members 17 adjust the amount of deflection of the spring member 16 by adjusting the screw-engagement in order to set (adjust) the pressure of the spring member 16 to be applied to the piezoelectric device 10 via the holding member 15. That is, the threaded members 17 adjust the pressure of the spring member 16 to be applied to the piezoelectric device 10. As a result, the spring member 16 urges the holding member 15 with a desired pressure to position and hold the piezoelectric device 10 relative to the case 13, so that the friction contact members 11 are kept in pressure contact with the driven body 12 to be able to drive the driven body 12 under friction. In the meantime, the threaded members 17 also act as a pressure generation section which generates a pressure for pressing the spring member 16.

The spring member 16 is made of such metal material as stainless steel for spring or beryllium copper. The holding member 15 is made of a resin material such as reinforced plastic, for example, PPS, PEEK material and the like. The holding member 15 is formed integrally with the spring member 16 by insert molding. For the holding member 15, it is possible to use thermoplastic resin or thermosetting resin as the reinforced plastic. As shown in FIG. 3, for example, the spring member 16 comprises cutout sections 16a and an opening 16b at a position where it makes contact with the holding member 15. Consequently, the spring member 16 can enhance robustness of the holding member 15 therewith by insert molding.

The holding member 15 comprises, for example, cylindrical protrusions 151. More specifically, the protrusions 151 are provided projectingly on both sides of the holding member 15 in direction Y corresponding to the node of the longitudinal vibration of the piezoelectric device 10. The protrusions 151 are accommodated in guide grooves 131 provided on the case 13. As a result, the piezoelectric device 10 is so constructed that its positions in direction X and in the rotation direction about the Z-axis are restricted by the protrusions 151 of the holding member 15. At the same time, the protrusions 151 are located in proximity to the case 13 comprising the guide grooves 131. Consequently, the positions of the piezoelectric device 10 about the X- and Y-axes are restricted. That is, the spring member 16 is positioned and held in the case 13.

Flexible cables 18 are fixed to the top face side of the piezoelectric device 10, for example, with conductive adhesive agent. The piezoelectric device 10 is connected to a driving circuit (not shown) through the flexible cable 18. A voltage is applied to the piezoelectric device 10 through this driving circuit. As a result, as described above, the ultrasonic motor induces the longitudinal vibration and flexural vibration at the same time corresponding to this voltage so as to produce the elliptical vibration. Then, the ultrasonic motor obtains a driving force produced by the aforementioned elliptical vibration and transmits the driving force to the driven body 12 through the friction contact members 11 thereby driving the driven body 12 relatively.

With the above-described structure, when assembling the ultrasonic motor, the holding member 15 integrated with the spring member 16 is fixed to a position corresponding to, for example, the node of the longitudinal vibration of the piezoelectric device 10 having fixed thereto the friction contact members 11, with adhesive agent. Then, with the piezoelectric device 10 placed on the driven body 12 via the friction contact members 11, the driven body 12 is disposed in the case 13 via rolling members 14 so that the driven body 12 can be moved freely in direction X. In this state, the protrusions 151 on the holding member 15 are accommodated in the guide grooves 131 and the threaded members 17 are disposed on both ends of the spring member 16 integrated with the holding member 15 in order to adjust the pressure to be applied to the piezoelectric device 10.

Then, in the piezoelectric device 10, the flexible cables 18 disposed on the top surface of the piezoelectric device 10 are connected to the above-mentioned driving circuit (not shown). When a voltage is applied to the piezoelectric device 10 via this driving circuit (not shown), the elliptical vibration is generated in the piezoelectric device 10 so as to drive the driven body 12 in direction X with respect to the case 13 via the friction contact member 11 by the elliptical vibration as a driving force.

As described above, in the ultrasonic motor, the spring member 16 is formed integrally with the holding member 15, and the holding member 15 is disposed and fixed at the node of the longitudinal vibration of the piezoelectric device 10. The threaded members 17 for setting the pressure to be applied to the friction contact member 11 of the piezoelectric device 10 are disposed on both ends of the spring member 16 in direction X such that they can be adjusted freely.

Consequently, in the piezoelectric device 10, the spring member 16 integrated with the holding member 15 has a desired spring performance (pressure) and then, the holding member 15 is installed within the case 13. Thus, when assembling the ultrasonic motor, the work for installing the spring member 16 on the holding member 15 with setting of the initial spring force is eliminated thereby facilitating and simplifying the assembly work of the ultrasonic motor.

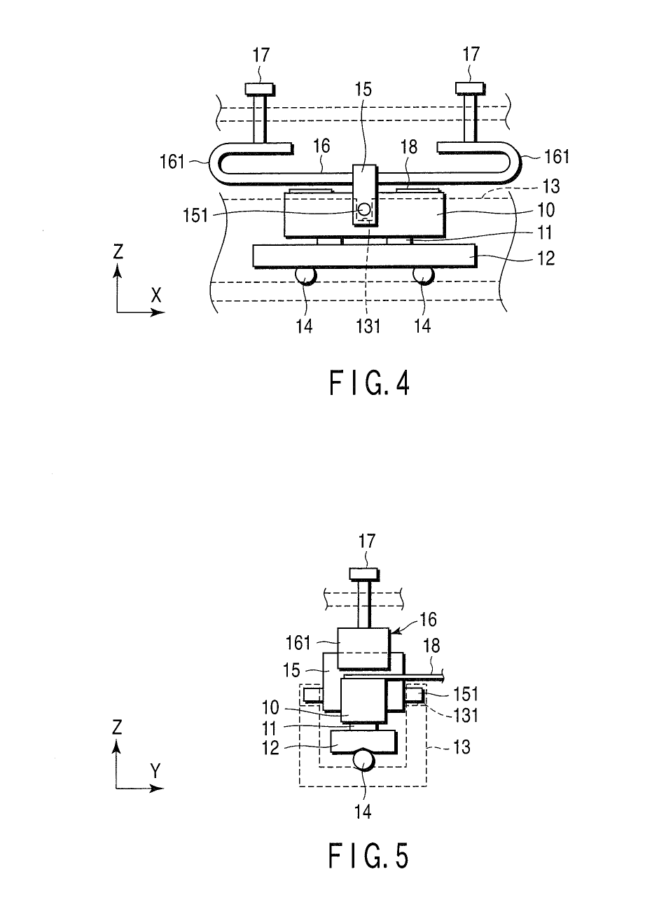

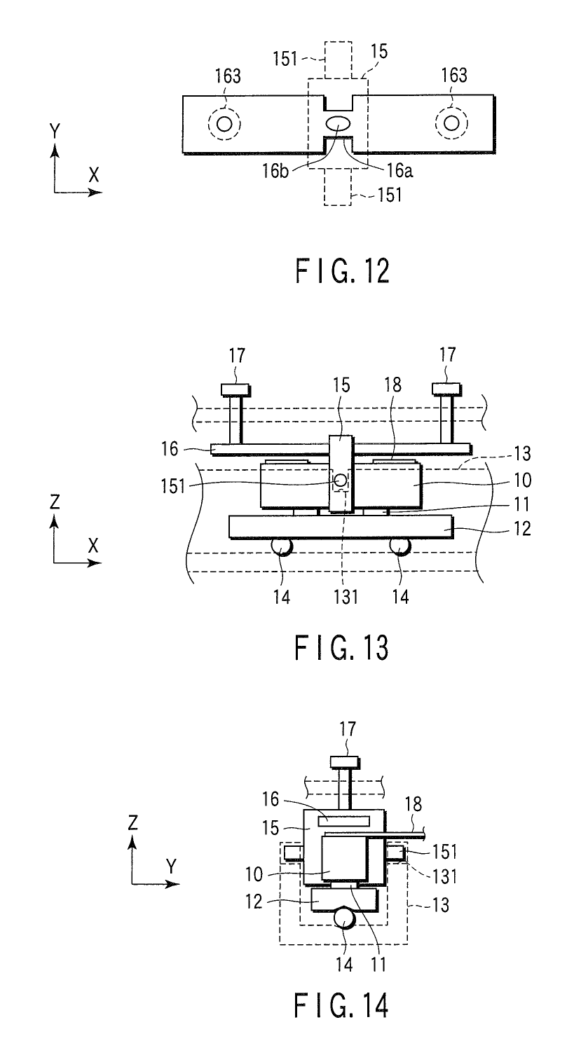

The present invention is not restricted to the above-described embodiment but may be configured as shown in FIGS. 4 to 17 while the same effect can be expected. In respective embodiments shown in FIGS. 4 to 17, the same reference numbers are attached to the same components as the embodiment shown in FIGS. 1 to 3 and a detailed description thereof is omitted.

According to an embodiment shown in FIGS. 4 and 5, bent sections 161 which are bent (curved) in a U shape are disposed on both ends of the spring member 16 in direction X across the holding member 15. The threaded member 17 is disposed in contact with the bent section 161. The threaded member 17 is disposed on the open end of the bent section 161 so as to adjust its engagement to the case 13. As a result of adjusting the engagement of the threaded member 17, an end of the threaded member 17 presses the bent section 161.

Consequently, a large deformable section can be secured in the spring member 16 and thus, the spring constant of the spring member 16 can be set to a smaller value. As a result, the pressure of the spring member 16 to be applied to the piezoelectric device 10 via the holding member 15 can be adjusted highly accurately. The above-mentioned deformable section includes the bent sections 161, indicating sections contributing to deformation of the spring member 16.

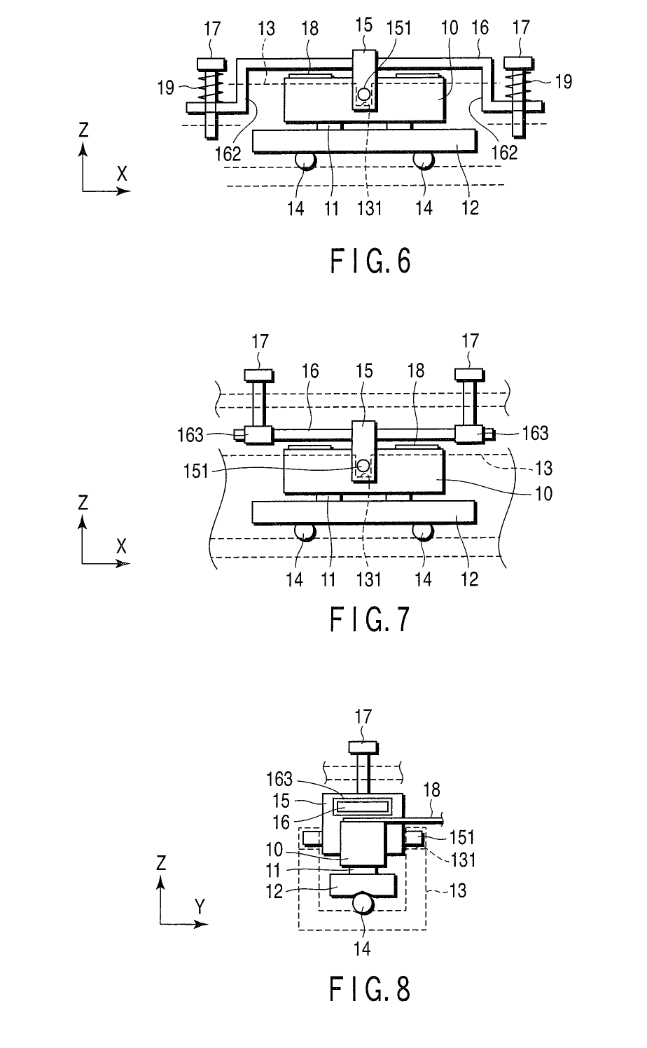

According to an embodiment shown in FIG. 6, bent sections 162 which are bent in a step-like form are disposed on both ends of the spring member 16 in direction X across the holding member 15. The threaded member 17 is disposed on the bent section 162. The threaded member 17 is inserted in a pressure adjusting coil spring 19 such that it can be moved smoothly. The pressure adjusting coil spring 19 is wound around the threaded member 17. The end of this threaded member 17 is screwed into the case 13 so that the threaded member 17 can be adjusted with respect to the case 13. As a result, the spring constant of the spring member 16 can be reduced and consequently, the pressure of the spring member 16 can be adjusted further accurately by the operation of the pressure adjusting coil spring 19.

Consequently, the threaded members 17 can be disposed on the bent sections 162, for example, without providing the case 13 with any cover (not shown). Further, the height of the ultrasonic motor including the structure of the threaded members 17 can be set to a small value thereby contributing to reduction in size of the ultrasonic motor.

According to an embodiment shown in FIGS. 7 to 9, resilient members 163 made of, for example, a resin material, on which the threaded member 17 is to be installed, are disposed on both ends of the spring member 16 in direction X across the holding member 15 by integral molding. The resilient member 163 is in the shape of, for example, headband which surrounds the outer peripheries of the both ends of the spring member 16 in direction X. The position where the resilient member 163 is formed corresponds to the position of the end of the threaded member 17. The end of the threaded member 17 engages the resilient member 163 to adjust the pressure of the spring member 16. As a result, the spring member 16 can absorb a collision vibration caused by a contact between the spring member 16 and the threaded member 17 by the elastic force of the resilient member 163. Thus, the ultrasonic motor can obtain more accurate driving characteristics.

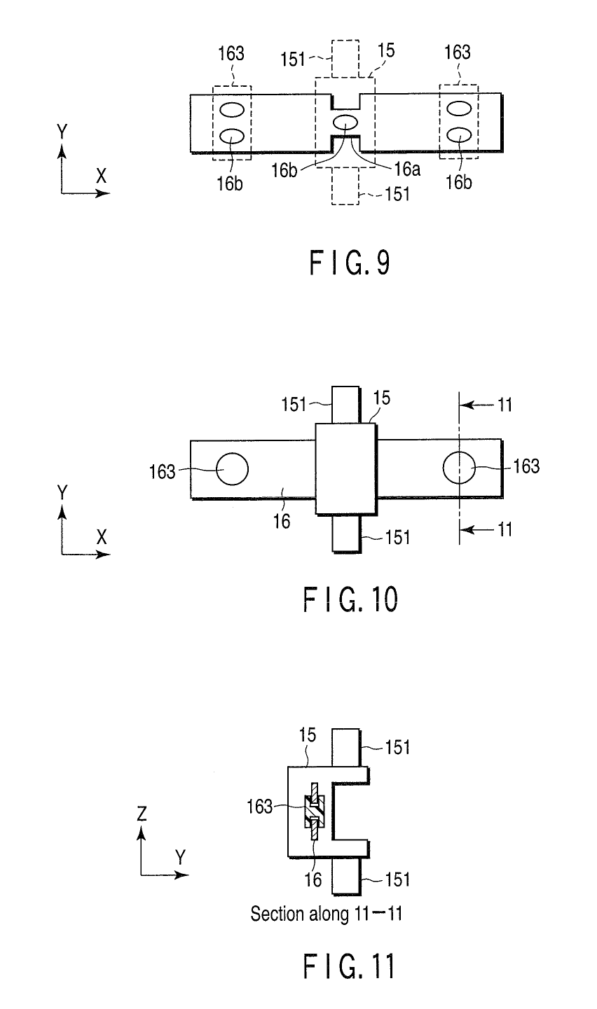

According to this embodiment also, the spring member 16 comprises a cutout section 16a and an opening 16b at a position where it makes contact with the holding member 15 as shown in FIG. 9 and further comprises, for example, openings 16b at positions where it makes contact with the resilient members 163. By the spring member 16 is formed the holding member 15 by insert molding, the spring member 16 can be formed integrally with the holding member 15 and the resilient member 163 robustly.

Note that the resilient member 163 does not need to cover the outer peripheries of both ends of the spring member 16. The resilient members 163 are disposed to oppose the ends of the threaded members 17 at intermediate positions in direction Y on both ends in direction X of the spring member 16 as shown in FIGS. 10 to 12. At this time, the resilient members 163 may be formed in a circular shape like, for example, an island.

According to an embodiment shown in FIGS. 13 and 14, the holding member 15 is formed integrally with the spring member 16 by insert molding, so that the holding member 15 is formed integrally at a position corresponding to the node of the longitudinal vibration of the piezoelectric device 10. As a result, the work of installing the holding member 15 on the piezoelectric device 10 is eliminated thereby further enhancing the work efficiency of installation of the ultrasonic motor.

The structures shown in FIGS. 4 to 12 can be applied also to this embodiment.

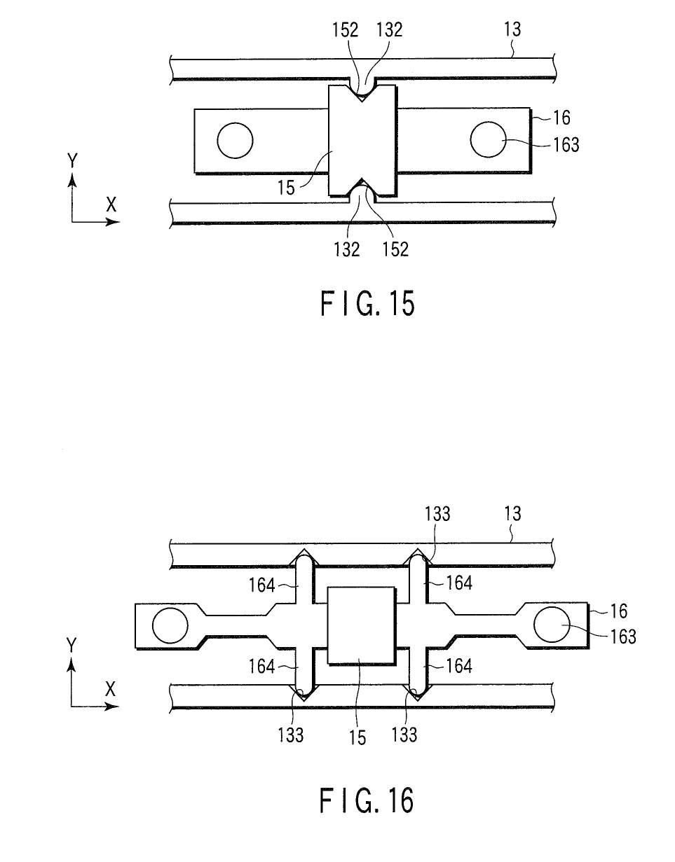

Further, an embodiment shown in FIG. 15 includes a positioning arrangement mechanism for positioning and arranging, for example, the piezoelectric device 10 within the case 13. In this positioning arrangement mechanism, a pair of positioning recesses 152 are disposed on both ends of the holding member 15 in direction Y across the piezoelectric device 10. According to this positioning arrangement mechanism, the case 13 has provided thereon positioning protrusions 132. The positioning arrangement mechanism determines the position of the piezoelectric device 10 by engaging the positioning protrusions 132 with the positioning recesses 152.

FIG. 16 shows the positioning arrangement mechanism which positions, for example, the piezoelectric device 10 within the case 13. In this positioning arrangement mechanism, two pairs of the protrusions 164, each pair being arranged in direction Y, are provided on both ends of the spring member 16 in the lengthwise direction (direction X) of the piezoelectric device 10 across the holding member 15. Further, in this positioning arrangement mechanism, recesses 133 are provided at positions opposing the protrusions 164 of the case 13. This positioning arrangement mechanism determines the position of the piezoelectric device 10 by engaging the protrusion 164 with the recess 133. In the meantime, the protrusions 164 may be disposed in the case 13 while the recesses 133 may be disposed in the spring member 16.

In each embodiment shown in FIGS. 15 and 16, the resilient members 163 are formed integrally with the spring member 16 on both ends of the spring member 16 in direction X. Consequently, a further excellent effect can be expected. In each of the embodiments, the spring member 16 may be provided with the same bent sections 161 as the above-described embodiment shown in FIGS. 4 and 5 or may be provided with the same bent section 162 as the embodiment shown in FIG. 6.

Accordingly, the present invention is not restricted to the above-described embodiments, but a variety of modifications may be implemented within the scope not departing from the spirit of the invention on each stage for carrying out the present invention. Further, the above-described embodiments contain a variety of aspects of the invention and the variety of aspects of the invention may be extracted by combining disclosed multiple components appropriately.

Even if some of the components indicated in the embodiments are removed, the object of the invention intended to be attained by the invention may be attained and when the effect described as the effect of the invention is attained, a composition excluding these removed components can be extracted as another aspect of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor in which longitudinal vibration and flexural vibration are induced at the same time to generate elliptical vibration and driving force is obtained from the elliptical vibration to drive a driven body relatively, the ultrasonic motor comprising:
a piezoelectric device;
friction contact members which are disposed on the piezoelectric device to transmit the driving force to the driven body;
a holding member which is disposed on the piezoelectric device and positioned and held within a case;
a pressure member which is formed integrally with the holding member to press the friction contact members to the driven body via the piezoelectric device so that the driven body is capable of being driven under friction; and
a pressure adjusting mechanism which adjusts the pressure of the pressure member to be applied to the piezoelectric device.

2. The ultrasonic motor according to claim 1, wherein the holding member is formed integrally with the pressure member and the piezoelectric device.

3. The ultrasonic motor according to claim 1, wherein the pressure member comprises bent sections on both ends of the pressure member across the holding member.

4. The ultrasonic motor according to claim 1, wherein the pressure adjusting mechanism comprises pressure generation sections.

5. The ultrasonic motor according to claim 1, wherein the pressure member comprises resilient members on which the adjusting mechanism is to be installed, the resilient members being formed on both ends of the pressure member across the holding member by integral molding.

6. The ultrasonic motor according to claim 1, wherein the pressure member is formed of metal material.

7. The ultrasonic motor according to claim 1, wherein the pressure member comprises protrusions or recesses at sections where the pressure member is to engage the case.

8. The ultrasonic motor according to claim 1, wherein the pressure member is positioned in and held by the case while the holding member is disposed separately from the case.

9. The ultrasonic motor according to claim 8, wherein the holding member is formed integrally with the pressure member and the piezoelectric device.

10. The ultrasonic motor according to claim 8, wherein the pressure member comprises bent sections on both ends of the pressure member across the holding member.

11. The ultrasonic motor according to claim 8, wherein the pressure adjusting mechanism comprises pressure generation sections.

12. The ultrasonic motor according to claim 8, wherein the pressure member comprises resilient members on which the adjusting mechanism is to be installed, the resilient members being formed on both ends of the pressure member across the holding member by integral molding.

13. The ultrasonic motor according to claim 8, wherein the pressure member is formed of metal material.

14. The ultrasonic motor according to claim 8, wherein the pressure member comprises protrusions or recesses at sections where the pressure member is to engage the case.
